(19) United States
(12) Patent Application Publication
(10) Pub. No.: US 2018/0004915 A1
(43) Pub. Date: Jan. 4, 2018

(54) GENERATING PERFORMANCE ASSESSMENT FROM HUMAN AND VIRTUAL HUMAN PATIENT CONVERSATION DYADS DURING STANDARDIZED PATIENT ENCOUNTER

(71) Applicants: Thomas B. Talbot, New Market, MD (US); Mark Core, Marina del Rey, CA (US); Eric Forbell, Van Nuys, CA (US); Nicolai Kalisch, Long Beach, CA (US); Albert Rizzo, Los Angeles, CA (US)

(72) Inventors: Thomas B. Talbot, New Market, MD (US); Mark Core, Marina del Rey, CA (US); Eric Forbell, Van Nuys, CA (US); Nicolai Kalisch, Long Beach, CA (US); Albert Rizzo, Los Angeles, CA (US)

(73) Assignee: UNIVERSITY OF SOUTHERN CALIFORNIA, Los Angeles, CA (US)

(21) Appl. No.: 15/543,210

(22) PCT Filed: Jan. 13, 2016
(86) PCT No.: PCT/US16/13146

§ 371 Date: Jul. 12, 2017

Related U.S. Application Data
(60) Provisional application No. 62/102,975, filed on Jan. 13, 2015.

(51) Int. Cl. G06F 19/00; G09B 7/06

(52) U.S. Cl. CPC G06F 19/363; G06F 19/345; G09B 7/06

(57) ABSTRACT

An artificial intelligence machine may quickly generate a comprehensive virtual patient interview database based on limited input from a case author. The comprehensive virtual patient interview database may include a list of topics and a set of items. Each item may be related in the database to one of the topics and may include one or more questions and one or more patient responses to each question. The artificial intelligence machine may include a data storage system that stores a universal medical taxonomy database that includes a list of topics and a set of items, each item being related in the database to one of the topics and including one or more questions and one or more default responses to each question; a user interface for receiving the limited input from the case author, the limited input including descriptive attributes of a real or fictitious patient; and a data processing system that includes one or more processors and that generates the comprehensive virtual patient interview database by modifying one or more of the default responses in the universal medical taxonomy database based on the descriptive attributes.

### CROSS-REFERENCE TO RELATED APPLICATION

This application is based upon and claims priority to U.S. provisional patent application 62/102,975, entitled “Generating Performance Assessment from Human and Virtual Human Patient Conversation Dyads During Standardized Patent Encounter,” filed Jan. 13, 2015, attorney docket number 094852-0059. The entire content of this application is incorporated herein by reference.

### STATEMENT REGARDING FEDERALLY SPONSORED RESEARCH

This invention was made with government support under Contract No. W911NF-04-D-0005 awarded by the U.S. Army Research Laboratory. The government has certain rights in the invention.

### BACKGROUND

### Technical Field

This disclosure relates to virtual conversational patients and to systems and methods that create them.

### Description of Related Art

A virtual interface patient may be a computer-based system that receives medically-related questions and provided answers comparable to a real patient with one or more medical conditions.

Virtual interactive patients may have a number of limitations. Each may require preparation of a database, sometimes referred to herein as a virtual interactive case, that may require an extensive and unique authoring process that can be highly laborious and time intensive whereby every possible patient question and answer is manually placed into a system. Such systems may require each case to be a separate development effort and may be require many months to author a single case. Such systems may also lack flexibility outside the case domain, limited ability to understand natural language questions, and may be unable to provide any assessment of the quality of the questions or only a very rudimentary assessment. The authoring approach may also leave out aspects of the patient unrelated to the case that could serve as a clue to fruitful areas of questioning.

### SUMMARY

An artificial intelligence machine may quickly generate a comprehensive virtual patient interview database based on limited input from a case author. The comprehensive virtual patient interview database may include a list of topics and a set of items. Each item may be related in the database to one of the topics and may include one or more questions and one or more patient responses to each question. The artificial intelligence machine may include a data storage system that stores a universal medical taxonomy database that includes a list of topics and a set of items, each item being related in the database to one of the topics and including one or more questions and one or more default responses to each question; a user interface for receiving the limited input from the case author, the limited input including descriptive attributes of a real or fictitious patient; and a data processing system that includes one or more processors and that generates the comprehensive virtual patient interview database by modifying one or more of the default responses in the universal medical taxonomy database based on the descriptive attributes.

The data processing system may add one or more tags to one or more of the items based on the limited input from the author. At least one of the tags may be indicative of the importance of the item associated with the tag.

The data processing system may associate at least one of the items with one or more of the other items based on the limited input from the author.

The default responses may all be indicative of responses from a normal healthy patient.

A response to a question may be a question that a learner using the database must answer. The question may include a set of choices, one of which the learner may select.

A non-transitory, tangible, computer-readable storage media containing a program of instructions that, when run in an artificial intelligence machine of any of the types described herein, may cause the data processing system in the machine to perform one or more of the functions of the data processing system as recited herein.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates an example of an online virtual standardized patient training system and possible components within an artificial intelligence machine.

FIG. 2 illustrates an example of a unified patient taxonomy database that may contain a full patient description.

FIG. 3 illustrates an example of a virtual patient authoring user interface and the placement of assessment tags within an authoring system.

FIG. 4 illustrates an example of logic flow of a physician-patient interaction during a medical interview.

FIG. 5 illustrates an example of a case-specific patient taxonomy.

FIG. 6 illustrates an example of a partial representation, or mind map, or case-specific patient taxonomy under conditions of partially successful performance.

FIG. 7 illustrates an example of an artificial intelligence machine that generates a comprehensive virtual patient interview database based on limited input from a case author and a unified medical taxonomy database.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

Virtual conversational patients may facilitate a cycle or interaction between human learners and computer software. For such training interactions, the learner may select a desired question from a list of questions or may type or speak a question. If a spoken or typed question is asked, then a natural language processing system may attempt to interpret the question and match it to a question in a virtual patient's response database. If a match is found, then the virtual patient may provide a response to the learner through text, verbal and/or an animated response.

A conversational virtual patient interaction system may quantify the value of the learner's (in the role of medical interviewer) questions as they pertain to the medical situation at hand in the patient case scenario. High value learner (e.g., physician) questions may be determined by the usefulness of information gained through asking specific questions. Medical interviewer performance may be determined by the percentage of assessment tags earned, the importance rating of assessment tags earned, and/or the ability to obtain the highest number of tags in the fewest number of questions when there are responses that may reward multiple tags from the virtual patient. Since tags may be associated with more than one taxonomy item, a variety of questioning strategies may reward tags in a similar manner to human patient encounters; where a conversation may have more than one pathway to elicit a critical information item.

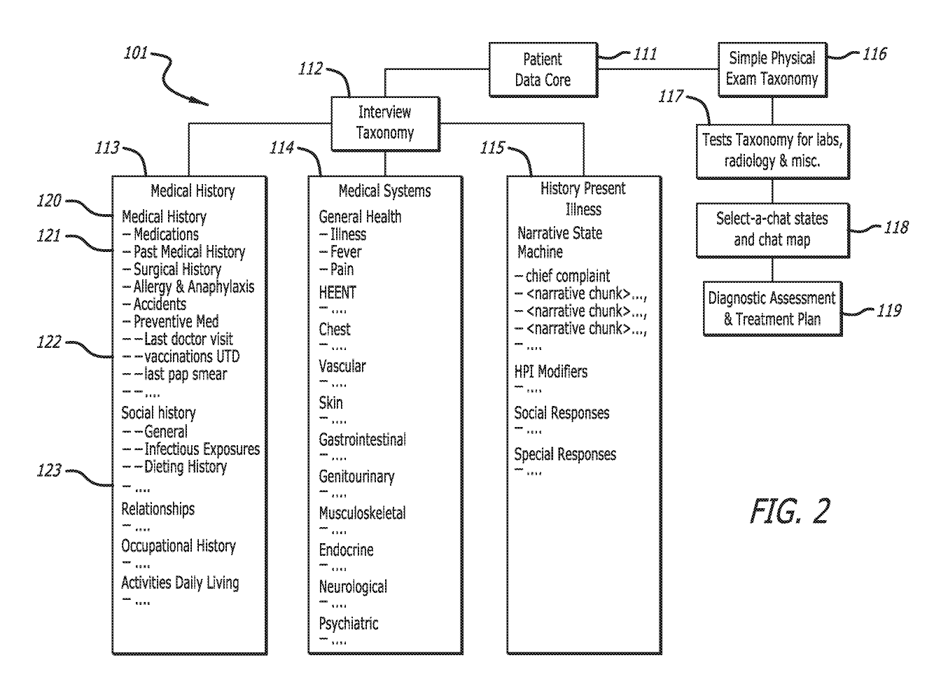

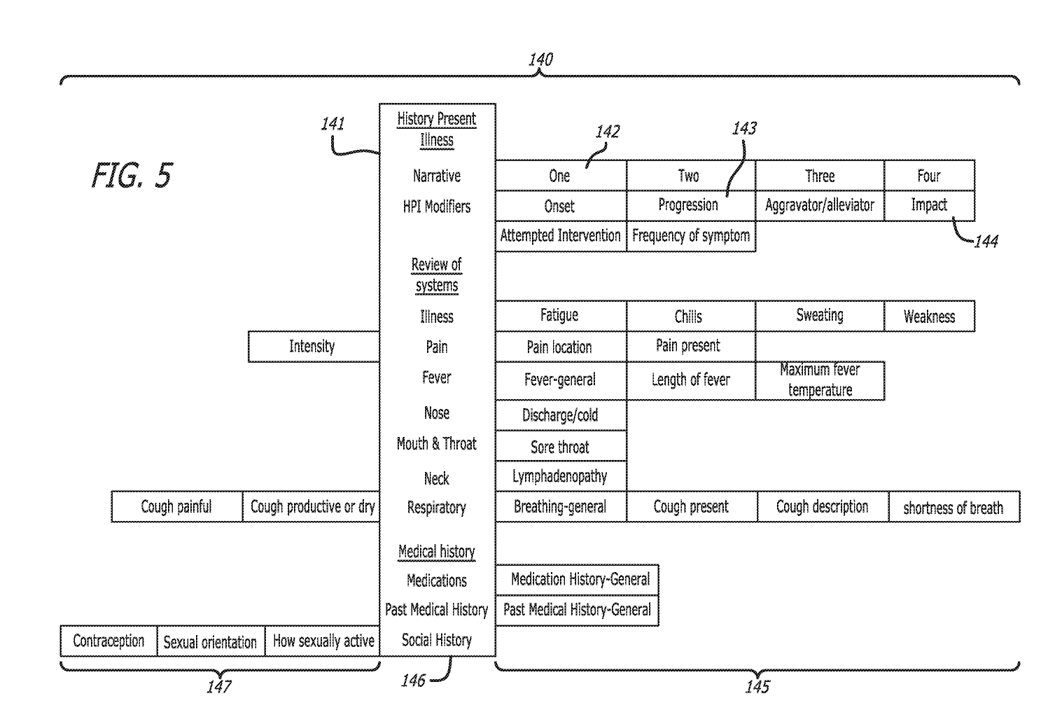

In a virtual patient setting, each patient case may be a large database that is based around a unified medical taxonomy, an example of which is illustrated in FIG. 2. This database may describe all a wide array of relevant and case-irrelevant data for every possible patient. Such a taxonomy may include hundreds or thousands of verbal responses to medical questions, test results, and physical examination findings. All patients in such a system may employ the same unified medical taxonomy. When a case is authored, the author may modify data within the unified medical taxonomy and create a case-specific medical taxonomy, as defined by the author. The case-specific taxonomy may be portions of the unified medical taxonomy that are relevant to the case diagnosis at hand. The author may determine this relevance by assigning assessment tags to the taxonomy. The case-specific taxonomy may include tagged portions of the unified medical taxonomy, as illustrated in FIG. 5.

There may be various assessment tags of high-value or low-value and even punitive value. Tags may be coded to award a specific point value or color; enabling a means by which a virtual patient system may identify higher priority information in the case. A punitive tag, with negative score value, may be employed to provide corrective feedback for exploring interview areas deemed counterproductive by the case author. The higher-value tags may determine the most critical information to obtain. Each tag may contain metadata to associate that taxonomy tag with a specific diagnosis, user feedback, tag value or other information. In addition to tags, taxonomy items may contain information: verbal response to a question, laboratory test values, and/or a physical finding, for example.

It is possible within a verbal response to reveal a great deal of information, It is thus possible to not only provide an assessment tag to provide credit for eliciting that taxonomy item's information, but it is also possible to attach assessment tags from other parts of the taxonomy, called association tags, to credit the learner with obtaining additional off-topic information that was revealed in that response. This powerful capability can enable high efficiency simulated medical encounters and can allow for information to be obtained by learners through more than one route. In such an example, a learner can obtain a great deal of learning credit by listening to all of a patient narrative, by asking open-ended questions, by asking many specific question, or by any combination of these approaches. The amount of information may be equal between these both open and closed questioning approaches, but the efficiency, based on the number of interactions with the patient required vs. amount of information returned, may be different between the approaches. A virtual patient system may determine the optimal efficiency of questioning based on the distribution of tags and may provide feedback as to how to increase interview efficiency by asking questions that elicit multiple tags in the response.

The use of assessment tags and association tags can provide a turn-based granular measurement of both the value of learner questions as well as the value of information returned by the virtual patient. Through longitudinal graphing, it is possible to construct an information gain, or learning curve, that plots medical interviewer progress as graph that shows the score at every interview step. This graph can be interpreted to pinpoint areas of learner success and struggle.

Conversely, once information gain has been determined, it is possible for a virtual patient assessment system to assess information that was not successfully obtained during the simulated encounter and report on deficiencies.

Assessment tags may be placed onto the case-specific patient taxonomy, a subset of the Unified Medical Taxonomy that is defined by such placement. By employment of these embodiments, it is possible to determine the information gained from the patient by each question asked of the learner (Physician). This information may be learned through a direct inquiry (regular assessment tag) or by exposition from the patient due to open ended questioning (association assessment tags).

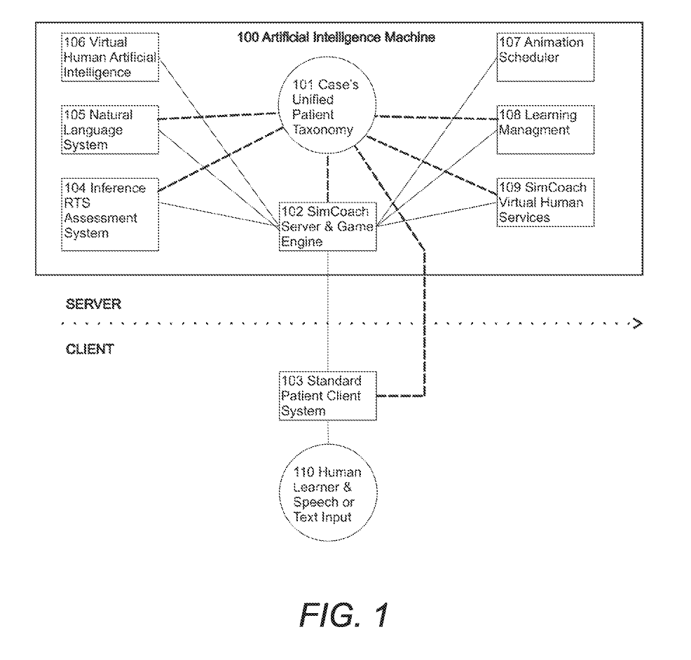

FIG. 1 illustrates an example of an artificial intelligence machine 100 in the form of an online virtual standardized patient training system and possible components. A case-specific unified patient taxonomy 101 may be the unified medical taxonomy with case-specific responses and customized placement of assessment tags. The human learner may employ a computer or tablet device to speak to or type in questions 110. A patient client 103 may send and receive queries to a server-based game engine 102, which may coordinate all playback activities.

This game engine may employ virtual human artificial intelligence 106, a natural language understanding system 105, an animation scheduler 107, learning management services 108, and SimCoach virtual human services 109. Learner assessment may be managed by direct interaction with an Inference-RTS assessment system 104.

The artificial intelligence machine 100 may contain a number of specific technologies to enable the desired interactions. The natural language understanding system 105 may be a LEXI Mark I, a new and vastly improved NLU system specifically developed for medical interactions. It may be closely tied to the unified medical taxonomy and may include lexical assessment, probabilistic modeling, and content matching approaches. The Lexi may be capable of improving performance through human-assisted and machine learning. The LEXI Mark I may translate the text of spoken or typed questions and responses from the user and may evaluate the unified medical taxonomies associated training language for a matching taxonomy item. The virtual human artificial intelligence system 106 may then evaluate the association between the query and the taxonomy item and determine the patient response. The response may be a simple response from the taxonomy, a challenging question back to the medical interviewer, or it may be an advancing narrative or variable dependent response.

The SimCoach virtual human engine (102, 107, 109) may provide virtual human services 109 to create animations of patient utterances and may provide nonverbal or verbal emotional expression. Speech may be from a voice actor or synthesized. The SimCoach animation scheduler 107 may produce clips at authoring time of all patient interactions so that they may be ready to be called upon during virtual patient encounter. The animations may be live or prescheduled video clips. The SimCoach virtual human engine may enable the rapid creation of cloud-based online virtual humans. SimCoach virtual humans may work on current-generation web browsers. SimCoach may automate speech actions, animation sequencing, lip synching, non-verbal behavior, natural language understanding integration, and artificial intelligence processing and interaction management. SimCoach may produce complete online virtual humans using text and metadata. The SimCoach server may be augmented with game engine logic 102 that evaluates the interaction and provides ongoing communication with the inference RTS assessment system 104, as well as a learning management system 108 to track and record assessments.

Inference RTS 105 may be an advanced game-based assessment engine that is capable of analyzing human conversations in real-time and associating learner speech acts with effects on the unified medical taxonomy. The feedback intervention system may encapsulate diagnostic performance and provide learners with concrete improvement tasks, a MIND-MAP case taxonomy visualization and a learning-curve tool. The standard patient client system 103 may be a client based application or a web-browser resident interface that provides a user interface for the human-artificial intelligence machine interaction.

FIG. 2 illustrates an example of a unified patient taxonomy database 101 that may contain a full, universal patient description. Tagged and modified portions of this taxonomy are often-called the case-specific taxonomy, as it may contain the information that is relevant to the patient case in question. The taxonomy depicted in this embodiment may include taxonomies for a physical examination 116, tests such as lab tests, patient performance measures and radiological imaging 117, and assessment mappings for select-a-chat branching dialogue encounters 118 and diagnosis & treatment plan assessment 119. This information may all be kept under the umbrella of a patient data core 111, which may contain all the taxonomy and additional patient descriptive data. Also included may be the medical interview taxonomy 112, which may further contain three sections: medical history 113 (items related to past medical history, lifestyle and occupation), medical systems (biological systems of the body) 114, and history of present illness 115. The history of present illness (information relevant to the doctor visit and current problem) 115 may contain a narrative state machine that advances the primary line of conversation from the patient's story to the medical interviewer. In each taxonomy section, there may be multiple levels of taxonomy content. There may be first degree sections 120 representing major areas and second degree sections 121 representing more specific areas. Each second degree section may contain one or many (third degree) taxonomy items 122 which may contain dialogue responses, metadata, and may be bound to assessment tags (132). The “ . . . ” 123 indicates additional content of variable length that is omitted for clarify.

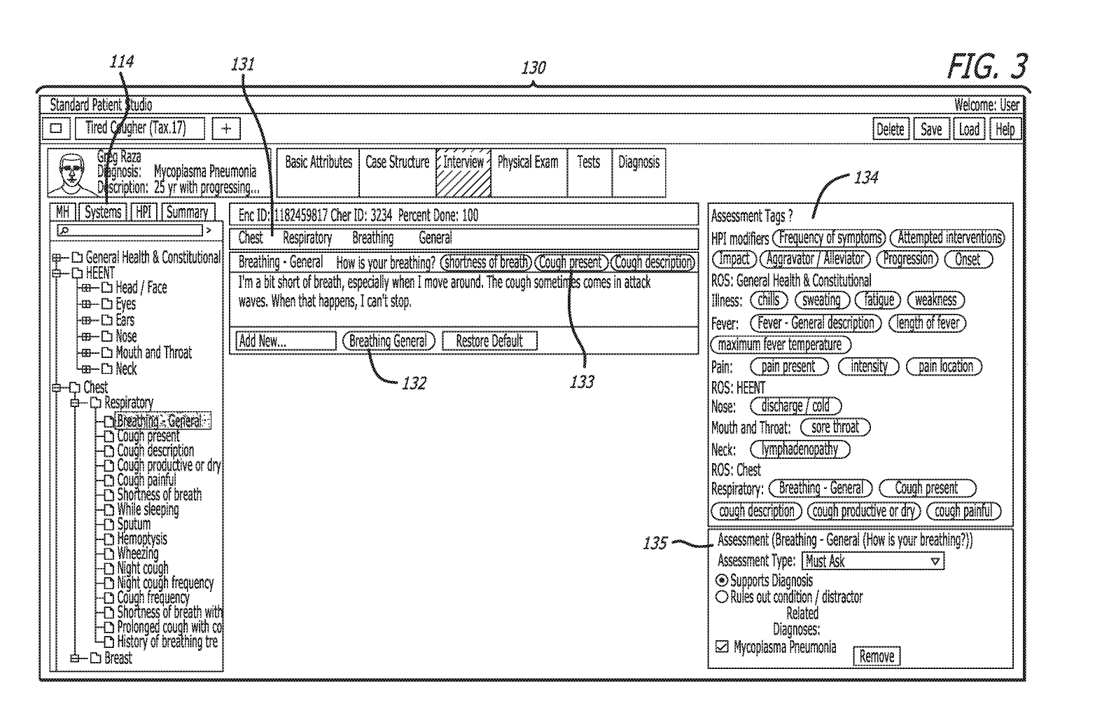

FIG. 3 illustrates an example of a virtual patient authoring user interface and the placement of assessment tags within an authoring system 130. The tagging system may allow authors to decorate their case with item specific declarations of case-specific relevance. This may permit inference-RTS assessment engine 104 to identify relevant case material for generating an assessment. An interview taxonomy section for medical systems 114 may be depicted as a specific third degree taxonomy item, such as “Breathing-General” 131.

The taxonomy item may contain an assessment tag 132 that may be specific to that taxonomy item. Taxonomy items may be categorized by multiple levels of points or priorities to indicate varying rewards or punishment for uncovering the responses related to the taxonomy item. The taxonomy item may include “association tags” 133 which may be assessment tags created for other taxonomy items, but that are copied to a new location to depict that the particular taxonomy item, and response in question returns information relevant to more than one location of the taxonomy. The figure also illustrates a visual map of assessment tags 134 for review or copying to create new association tags. In this manner, one assessment tax may be associated with one or many unified medical taxonomy items which may enable the functionality to determine success of a medical interview by responses elicited, rather than merely providing credit for questions. If an assessment tag is created, it is possible to add assessment tag metadata 135 that can provide additional information, such as pertinent positive/negative, associated diagnosis, priority level and/or learner feedback.

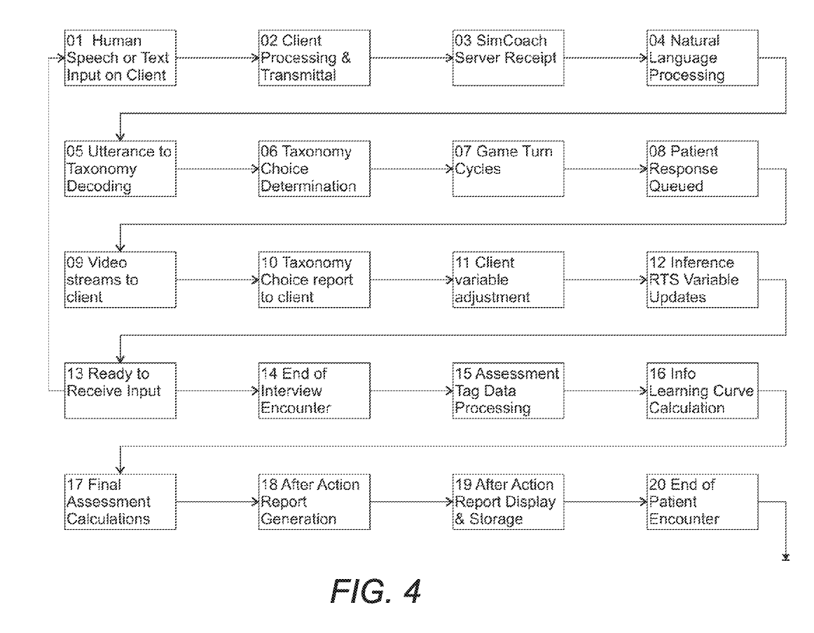

FIG. 4 illustrates an example of a flow chart that depicts interaction steps for a conversational virtual patient system. A human may provide speech content on the client computer 01. A client may parse and transmit the information to a server 02. The server/game engine may receive the information 03. The natural language processing system may interpret the text of the learner question 04. The natural language system may classify the interpreted text according to the context of the taxonomy 05 and, if possible, may make a taxonomy choice determination to provide an appropriate response 06.

Game engine cycles 07 may cycle to the next turn and the patient response may be queued 08. Video of the patient response may be streamed to a client machine 09, along with a taxonomy selection 10. Client machine variables may be adjusted 11, along with variables on the server inference RTS system which may update its records 12. The system may not be ready to receive another question 13, at which point it may returns to step 1. If the learner ends the encounter, a step 13 may proceed to close out the interview 14 by processing and recording assessment tag data 15, calculating a learning curve with the data 16, computing final assessment values 17, and generating an after-action report 18. The after-action report may be stored on the server and displayed to the learner 19. At this point, 20, the encounter may end.

FIG. 5 illustrates an example of a case-specific patient taxonomy 140. This representation may be a subset of the unified medical taxonomy 101 that represents case-specific included systems as a vertical spine 141. On the left side of the spine 147, data may be affiliated with non-present medical conditions to rule out. On the left side of the spine 145, data may be affiliated with medical conditions associated with the diagnosis in question. Items in the spine 146 may be associated with second-order taxonomy items 121 that contain case-relevant information due to their tagging. This map may contain special tags 142 that indicate the number of narrative steps present in the case. Assessment tags may be color or shape coded to determine a high reward 143 or a low reward 144 or even a negative reward (not depicted) value.

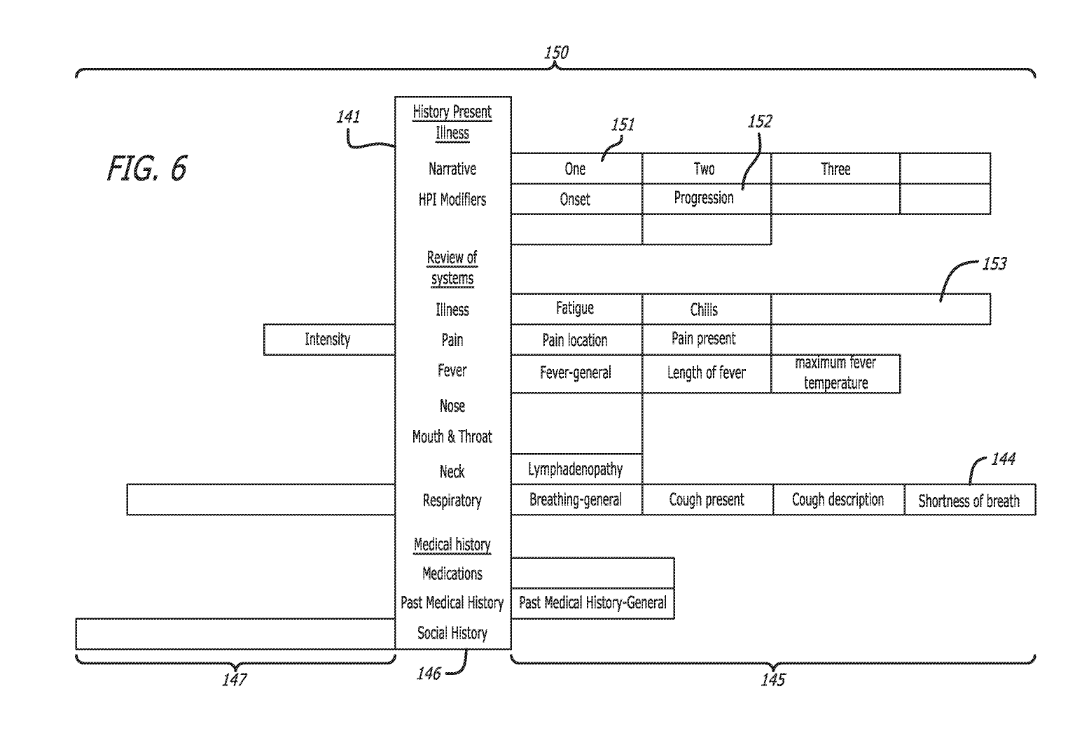

FIG. 6 illustrates an example of a partial representation 150, or mind map, or case-specific patient taxonomy under conditions of partially successful performance, as may be displayed to a learner for feedback purposes. Areas of the case-specific taxonomy that were uncovered by the learner are shown (151,152,144), but tags representing information that was not revealed after an encounter may remain hidden 153. This may serve to function as an assessment feedback device. The visible items may include narrative completion tags 151, high priority assessment tags 152, and low priority assessment tags 144.

Programs for teaching and assessment of medical student or a physician's patient diagnostic interviewing skills may include conversational interactions with virtual standardized patients. These conversations may involve transmitting questions in the form of text to a computer that processes the text containing these questions. Such a system may employ natural language processing software to determine appropriate responses by the virtual patient. This work may employ methods and designs to quantify value of the physician's questions, as relevant to the diagnosis, and provide for the ability to construct objective assessments of physician diagnostic interview performance. During an assessment, the medical interviewer may click on uncovered items in a mind map 153 to discover their content as a mechanism to learn how to improve performance on a future attempt of that particular virtual patient case.

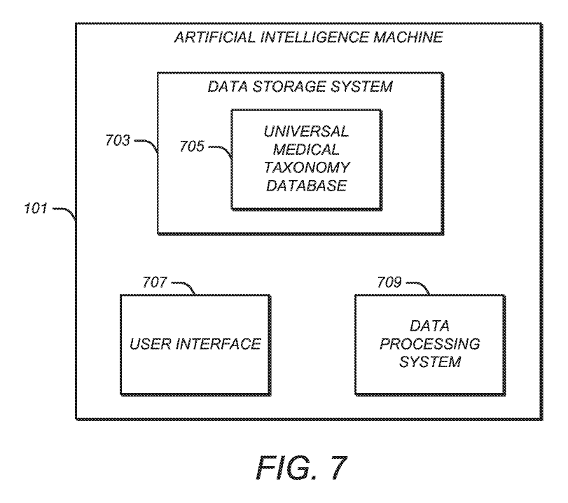

FIG. 7 illustrates an example of an artificial intelligence machine 101 that generates a comprehensive virtual patient interview database based on limited input from a case author and a unified medical taxonomy database 705. The comprehensive virtual patient interview database may include a list of topics and a set of items. Each item may be related in the database to one of the topics and including one or more questions and one or more patient responses to each question, the artificial intelligence machine 101 may include a data storage system 703 that stores the universal medical taxonomy database 705 that includes a list of topics and a set of items, each item being related in the database to one of the topics and including one or more questions and one or more default responses to each question. A user interface 707 may receive the limited input from the case author. The limited input may include descriptive attributes of a real or fictitious patient. A data processing system 709 may include one or more processors and may generate the comprehensive virtual patient interview database by modifying one or more of the default responses in the universal medical taxonomy database 705 based on the descriptive attributes.

The data processing system 709 may add one or more tags to one or more of the items based on the limited input from the author. At least one of the tags may be indicative of the importance of the item associated with the tag.

The data processing system 709 may associate at least one of the items with one or more of the other items based on the limited input from the author.

The default responses may all be indicative of responses from a normal healthy patient.

Unless otherwise indicated, the artificial intelligence machines that have been described may be implemented with a computer system configured to perform the functions that have been described herein for each of its components. The computer system may include one or more processors, tangible memories (e.g., random access memories (RAMs), read-only memories (ROMs), and/or programmable read only memories (PROMS)), tangible storage devices (e.g., hard disk drives, CD/DVD drives, and/or flash memories), system buses, video processing components, network communication components, input/output ports, and/or user interface devices (e.g., keyboards, pointing devices, displays, microphones, sound reproduction systems, and/or touch screens).

The computer system may include one or more computers at the same or different locations. When at different locations, the computers may be configured to communicate with one another through a wired and/or wireless network communication system.

The computer system may include software (e.g., one or more operating systems, device drivers, application programs, and/or communication programs). When software is included, the software includes programming instructions and may include associated data and libraries. When included, the programming instructions are configured to implement one or more algorithms that implement one or more of the functions of the computer system, including its various modules and subsections, as described herein. The description of each function that is performed by the computer system also constitutes a description of the algorithm(s) that performs that function.

The software may be stored on or in one or more non-transitory, tangible storage devices, such as one or more hard disk drives, CDs, DVDs, and/or flash memories. The software may be in source code and/or object code format. Associated data may be stored in any type of volatile and/or non-volatile memory. The software may be loaded into a non-transitory memory and executed by one or more processors.

The components, steps, features, objects, benefits, and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits, and/or advantages. These also include embodiments in which the components and/or steps are arranged and/or ordered differently.

For example, the virtual interactive patient may be deployed into an artificial intelligence machine that resides in a manikin or robot, enabling a robotic virtual interactive patient. The machine may be coupled with visual and auditory sensors to provide for emotional reciprocity and evaluation by the artificial intelligence machine. Subconversations and structured choice-based conversations that begin when a taxonomy based response may be added and appropriately triggered during the medical interview. The medical interview may be combined with other modules and portions of the medical encounter whereby the virtual patient may accept commands that may relate to laboratory procedures, imaging procedures, physical examination, physical maneuvers and physical, neurological and/or psychological tests. The virtual interactive patient may be coupled with a high fidelity simulacrum or a scanned human individual whereby the virtual patient may resemble an actual human which may be useful for providing a continuity of interaction between human actors serving as patients and the virtual patients, for example. The virtual interactive patient may be coupled with physiology engines and interactive technologies to represent a dynamic patient that may undergo physiological changes and accept assessments and interventions that alter the clinical course. Full or abbreviated versions of the virtual interactive patient may be embedded into videogame characters and simulations containing one or many virtual medical patients.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases from a claim means that the claim is not intended to and should not be interpreted to be limited to these corresponding structures, materials, or acts, or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element proceeded by an “a” or an “an” does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended coverage of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

The invention claimed is:

1. An artificial intelligence machine that can quickly generate a comprehensive virtual patient interview database based on limited input from a case author, the comprehensive virtual patient interview database including a list of topics and a set of items, each item being related in the database to one of the topics and including one or more questions and one or more patient responses to each question, the artificial intelligence machine comprising:
a data storage system that stores a universal medical taxonomy database that includes a list of topics and a set of items, each item being related in the database to one of the topics and including one or more questions and one or more default responses to each question;
a user interface for receiving the limited input from the case author, the limited input including descriptive attributes of a real or fictitious patient; and
a data processing system that includes one or more processors and that generates the comprehensive virtual patient interview database by modifying one or more of the default responses in the universal medical taxonomy database based on the descriptive attributes.

2. The artificial intelligence machine of claim 1 wherein the data processing system adds one or more tags to one or more of the items based on the limited input from the author.

3. The artificial intelligence machine of claim 2 wherein at least one of the tags is indicative of the importance of the item associated with the tag.

4. The artificial intelligence machine of claim 3 wherein the data processing system associates at least one of the items with one or more of the other items based on the limited input from the author.

5. The artificial intelligence machine of claim 1 wherein the default responses are all indicative of responses from a normal healthy patient.

6. The artificial intelligence machine of claim 1 wherein a response to a question is a question that a learner using the database must answer.

7. The artificial intelligence machine of claim 6 wherein a response that is a question includes a set of choices, one of which the learner must select.

8. A non-transitory, tangible, computer-readable storage media containing a program of instructions that, when run in an artificial intelligence machine of the type recited in claim 1, causes the data processing system in claim 1 to perform the functions of the data processing system recited in claim 1.

9. The non-transitory, tangible, computer-readable storage media of claim 8 wherein the programming instructions, when run in the artificial intelligence machine, causes the data processing system to add one or more tags to one or more of the items based on the limited input from the author.

10. The non-transitory, tangible, computer-readable storage media of claim 9 wherein the at least one of the tags is indicative of the importance of the item associated with the tag.

11. The non-transitory, tangible, computer-readable storage media of claim 10 wherein the programming instructions, when run in the artificial intelligence machine, causes the data processing system to associate at least one of the items with one or more of the other items based on the limited input from the author.

12. The non-transitory, tangible, computer-readable storage media of claim 8 wherein the default responses are all indicative of responses from a normal healthy patient.

13. The non-transitory, tangible, computer-readable storage media of claim 8 wherein a response to a question is a question that a learner using the database must answer.

14. The artificial intelligence machine of claim 13 wherein a response that is a question includes a set of choices, one of which the learner must select.
